(19) United States
(12) Patent Application Publication
(10) Pub. No.: US 2019/0053555 A1
(43) Pub. Date: Feb. 21, 2019

(54) ELASTIC COMPOSITE FABRIC AND METHOD FOR MANUFACTURING THE SAME

(71) Applicant: GOLDEN PHOENIX FIBERWEBS, INC., Tainan City (TW)

(72) Inventors: Kenneth CHENG, Taipei City (TW); Eric SHYUU, Taipei City (TW)

(73) Assignee: GOLDEN PHOENIX FIBERWEBS, INC., Tainan City (TW)

(21) Appl. No.: 16/039,047

(22) Filed: Jul. 18, 2018

(30) Foreign Application Priority Data
Aug. 18, 2017 (TW) 106128103

(51) Int. Cl. A41D 31/00; D04H 1/4374

(52) U.S. Cl. CPC A41D 31/0038; D04H 1/4374; B32B 7/04; A41D 2500/30; A41D 2400/10

(57) ABSTRACT

A method for manufacturing an elastic composite fabric, includes a combining step, where an elastic outer layer is disposed onto a top side of an elastic nonwoven fabric which has characteristics to prevent penetration of a filling material, a fiber density of 0.8 to 5.0 denier and a weight of 8 to 100 g/sqm (±40%), and a first cloth body is disposed onto a bottom side of the nonwoven fabric, wherein the first cloth body is an elastic outer layer or elastic nonwoven fabric with a fiber density of 0.8 to 5.0 denier and a weight of 8 to 100 g/sqm (±40%); and a filling step: filling the filling material within several filling spaces between the elastic outer layer and the elastic nonwoven fabric or within several filling spaces between the elastic nonwoven fabric and the first cloth body in order to obtain the elastic composite fabric.

### CROSS-REFERENCE TO RELATED APPLICATION

This application claims the priority of Taiwanese patent application No. 106128103, filed on Aug. 18, 2017, which is incorporated herewith by reference.

### BACKGROUND OF THE INVENTION

### 1. Field of the Invention

The present invention relates generally to a fabric, and more particularly to an elastic composite fabric that is capable of preventing a filling material passing out therefrom and a method of manufacturing the same.

### 2. The Prior Arts

A thermal effect fabric (such as clothes, coats, vests, trousers, pillows and comforter) generally includes two outer layers and a filling material. The filling material usually is a substance having warmth keeping properties, such as cotton or down (soft feather), filled between the two outer layers. It is noted that the elasticity of the outer layer is poor, and the filling material penetrates the outer layers and detaches off the fabric, thereby resulting in several problems. Firstly, the fabric lacks elasticity and ductility, and provides poor comfort to the user. Secondly, the warmth of fabrics gradually declines as time passes by. Thirdly, the user's skin causes discomfort such as itching and even skin irritation when it comes into contact with the filling material. Fourthly, the filling material which detaches off the fabric becomes a burden on the environment.

In the past, the method for solving the detachment of the filling material off the thermal effect fabric is to apply a thermoplastic elastic film on the two outer layers. However, the price of the thermoplastic elastic film is very expensive, which undoubtedly increases the fabric's manufacturing cost, and it also affects the breathability of the thermal effect fabric.

### SUMMARY OF THE INVENTION

As such, the primary objective of the present invention is to provide a method for manufacturing an elastic composite fabric, in which, an elastic nonwoven fabric prevents a filling material from penetrating, covers the filling material partially or completely and prevents the filling material from passing through. The elastic composite fabric has good elasticity and ductility, and can effectively prevent the filling material detaching off the elastic composite fabric and preventing the filling material from passing through the elastic composite fabric. In other words, the thermal effect of the elastic composite fabric is maintained due to preventing the filling material from detachment. The user's skin will not come into contact with the filling material and does feel uncomfortable, such as itching or skin irritation, thereby reducing the burden on the environment.

Another objective of the present invention is to provide a method of manufacturing an elastic composite fabric that prevents a filling material from passing through, since an elastic nonwoven fabric having a characteristic of preventing the filling material from passing out is less expensive than a thermoplastic elastic film, so that the manufacturing cost can be effectively reduced.

A further objective of the present invention is to provide an elastic composite fabric, in which an elastic nonwoven fabric prevents a filling material from penetrating through, by covering the filling material partially or completely, so that the filling material is prevented from penetrating. The elastic composite fabric has good elasticity and ductility, and can effectively prevent the filling material from falling out of the elastic composite fabric and maintains the thermal effect of the elastic composite fabric. In other words, the user's skin does not contact with the filling material to avoid discomfort such as itching or skin problems, thereby reducing the environmental burden.

Still another objective of the present invention is to provide an elastic composite fabric, in which an elastic nonwoven fabric having the property of preventing the penetration of the filling material, since the elastic nonwoven fabric having a characteristic of preventing the filling material from passing out is less expensive than a thermoplastic elastic film, so that the manufacturing cost of the elastic composite fabric is lower than that of the conventional elastic composite fabric preventing the filling material from passing through.

For achieving the foregoing objectives, the present invention provides a method for manufacturing an elastic composite fabric, includes the following steps.

A combining step: combining an elastic outer layer onto a top side of an elastic nonwoven fabric, which has characteristics to prevent a filling material passing out therefrom, a fiber density of 0.8 to 5.0 denier and a weight of 8 to 100 g/sqm (±40%); and a first cloth body onto a bottom side of the elastic nonwoven fabric, wherein, the first cloth body being elastic and serves as another elastic outer layer or the first cloth body has characteristics to prevent the filling material passing out therefrom and serves as another elastic nonwoven fabric with fiber density of 0.8 to 5.0 denier and a weight of 8 to 100 g/sqm (±40%).

A filling step: filling the filling material within a plurality of filling spaces between the elastic outer layer and the elastic nonwoven fabric or within a plurality of filling spaces between the elastic nonwoven fabric and the first cloth body in order to obtain the elastic composite fabric that prevents the filling material from coming out through the elastic composite fabric.

Preferably, the combining of the elastic outer layer onto the top side of the elastic nonwoven fabric is selected from a group consisting of sewing thread stitching means, glue means, hot pressing and ultrasonic waves, wherein the combining of the first cloth body onto the bottom side of the elastic nonwoven fabric is selected from a group consisting of sewing thread stitching means, glue means, hot pressing and ultrasonic waves.

Preferably, the combining step further includes a step of combining a second cloth body onto a bottom side of the first cloth body such that the second cloth body is elastic and serves as yet another elastic outer layer, the first cloth body being an elastic nonwoven fabric having the characteristics of preventing the filling material from passing through the elastic composite fabric.

In one embodiment of the present invention, the combining of the elastic outer layer onto the top side of the elastic nonwoven fabric is selected from a group consisting of sewing thread stitching means, glue means, hot pressing and ultrasonic waves, and the combining of the first cloth body onto the bottom side of the elastic nonwoven fabric is selected from a group consisting of sewing thread stitching means, glue means, hot pressing and ultrasonic waves, and the combining of the second cloth body onto the bottom side of the first cloth body is selected from a group consisting of sewing thread stitching means, glue means, hot pressing and ultrasonic waves.

Preferably, the filling material consists of elastic fibers or a polymer mixed with extensible filling materials such that the filling material itself is extensible.

For achieving the foregoing objectives, the present invention provides an elastic composite fabric that includes an elastic nonwoven fabric, an elastic outer layer, a first cloth body and a filling material.

The elastic nonwoven fabric has characteristics to prevent a filling material passing out therefrom, a fiber density of 0.8 to 5.0 denier and a weight of 8 to 100 g/sqm (±40%).

The elastic outer layer is disposed onto a top side of the elastic nonwoven fabric.

The first cloth body is disposed onto a bottom side of the elastic nonwoven fabric, wherein, the first cloth body being elastic and serves as another elastic outer layer or the first cloth body has characteristics to prevent a filling material passing out therefrom and serves as another elastic nonwoven fabric with a fiber density of 0.8 to 5.0 denier and a weight of 8 to 100 g/sqm (±40%).

The filling material is filled within a plurality of filling spaces between the elastic outer layer and the elastic nonwoven fabric or within a plurality of filling spaces between the elastic nonwoven fabric and the first cloth body.

Preferably, the disposing of the elastic outer layer onto the top side of the elastic nonwoven fabric is selected from a group consisting of sewing thread stitching means, glue means, hot pressing and ultrasonic waves, and the disposing of the first cloth body onto the bottom side of the elastic nonwoven fabric is selected from a group consisting of sewing thread stitching means, glue means, hot pressing and ultrasonic waves.

In one embodiment, the elastic composite fabric of the present invention further includes a second cloth body disposed onto a bottom side of the first cloth body such that the second cloth body is elastic and serves as another elastic outer layer, the first cloth body being an elastic nonwoven fabric having the characteristics of preventing the filling material from passing through the composite fabric.

Preferably, the disposing of the elastic outer layer onto the top side of the elastic nonwoven fabric is selected from a group consisting of sewing thread stitching means, glue means, hot pressing and ultrasonic waves, and the disposing of the first cloth body onto the bottom side of the elastic nonwoven fabric is selected from a group consisting of sewing thread stitching means, glue means, hot pressing and ultrasonic waves, and the disposing of the second cloth body onto the bottom side of the first cloth body is selected from a group consisting of sewing thread stitching means, glue means, hot pressing and ultrasonic waves.

Preferably, the filling material consists of elastic fibers or a polymer mixed with extensible filling materials such that the filling material itself is extensible.

The advantages provided by the elastic composite fabric of the present invention are as follows: since the elastic nonwoven fabric having the property of preventing the filling material from coming out, covers the filling material partially and totally, so that the elastic composite fabric has good elasticity and is extensible, provides the heat preservation effect in addition that the user's skin does not come into contact with the filling material to avoid itching, such as skin irritation and other discomforts. It can also reduce environmental burdens. Moreover, the elastic nonwoven fabric having the property of preventing the penetration of the filling material is less expensive than the thermoplastic elastic film, so that the manufacturing cost can be effectively reduced.

### BRIEF DESCRIPTION OF THE DRAWINGS

The present invention will be apparent to those skilled in the art by reading the following detailed description of a preferred embodiment thereof, with reference to the attached drawings, in which:

FIG. 1a is a flow chart illustrating a method for manufacturing an elastic composite fabric according to a first embodiment of the present invention;

FIG. 1b illustrates a first combining step in the method for manufacturing the elastic composite fabric according to the first embodiment of the present invention;

FIG. 1c illustrates a second combining step in the method for manufacturing the elastic composite fabric according to the first embodiment of the present invention;

FIG. 1d illustrates a filling step in the method for manufacturing the elastic composite fabric according to the first embodiment of the present invention;

FIG. 2a is a flow chart illustrating a method for manufacturing an elastic composite fabric according to a second embodiment of the present invention;

FIG. 2b illustrates a first combining step in the method for manufacturing the elastic composite fabric according to the second embodiment of the present invention;

FIG. 2c illustrates a second combining step in the method for manufacturing the elastic composite fabric according to the second embodiment of the present invention;

FIG. 2d illustrates a filling step in the method for manufacturing the elastic composite fabric according to the second embodiment of the present invention;

FIG. 3a is a flow chart illustrating a method for manufacturing an elastic composite fabric according to a third embodiment of the present invention;

FIG. 3b illustrates a combining step in the method for manufacturing the elastic composite fabric according to the third embodiment of the present invention;

FIG. 3c illustrates a filling step in the method for manufacturing the elastic composite fabric according to the third embodiment of the present invention;

FIG. 4a is a flow chart illustrating a method for manufacturing an elastic composite fabric according to a fourth embodiment of the present invention;

FIG. 4b illustrates a first combining step in the method for manufacturing the elastic composite fabric according to the fourth embodiment of the present invention;

FIG. 4c illustrates a second combining step in the method for manufacturing the elastic composite fabric according to the fourth embodiment of the present invention;

FIG. 4d illustrates a filling step in the method for manufacturing the elastic composite fabric according to the fourth embodiment of the present invention;

FIG. 5a is a flow chart illustrating a method for manufacturing an elastic composite fabric according to a fifth embodiment of the present invention;

FIG. 5b illustrates a first combining step in the method for manufacturing the elastic composite fabric according to the fifth embodiment of the present invention;

FIG. 5c illustrates a second combining step in the method for manufacturing the elastic composite fabric according to the fifth embodiment of the present invention;

FIG. 5d illustrates a filling step in the method for manufacturing the elastic composite fabric according to the fifth embodiment of the present invention;

FIG. 6a is a flow chart illustrating a method for manufacturing an elastic composite fabric according to a sixth embodiment of the present invention;

FIG. 6b illustrates a first combining step in the method for manufacturing the elastic composite fabric according to the sixth embodiment of the present invention;

FIG. 6c illustrates a second combining step in the method for manufacturing the elastic composite fabric according to the sixth embodiment of the present invention; and

FIG. 6d illustrates a filling step in the method for manufacturing the elastic composite fabric according to the sixth embodiment of the present invention.

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention.

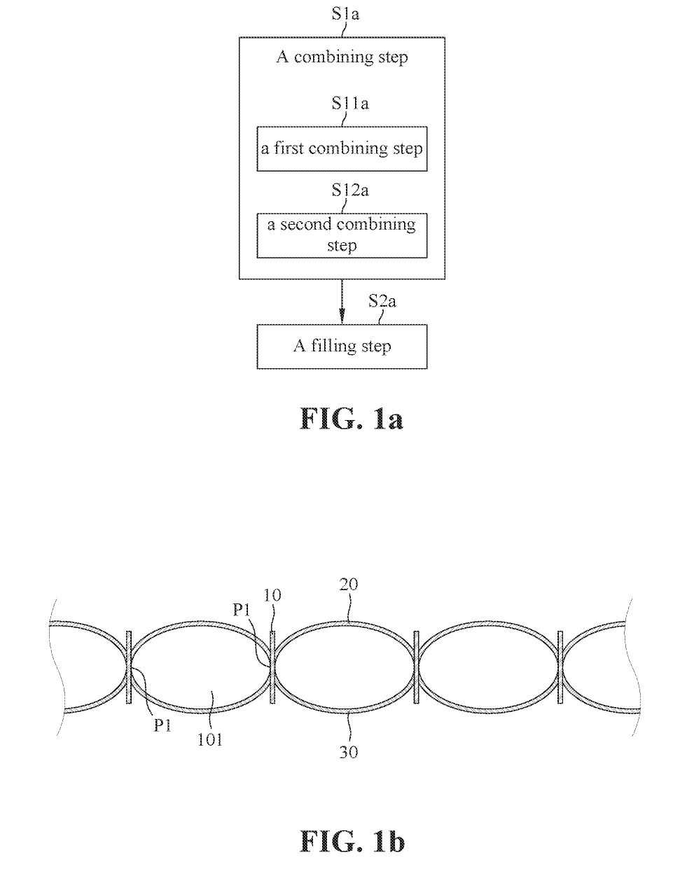

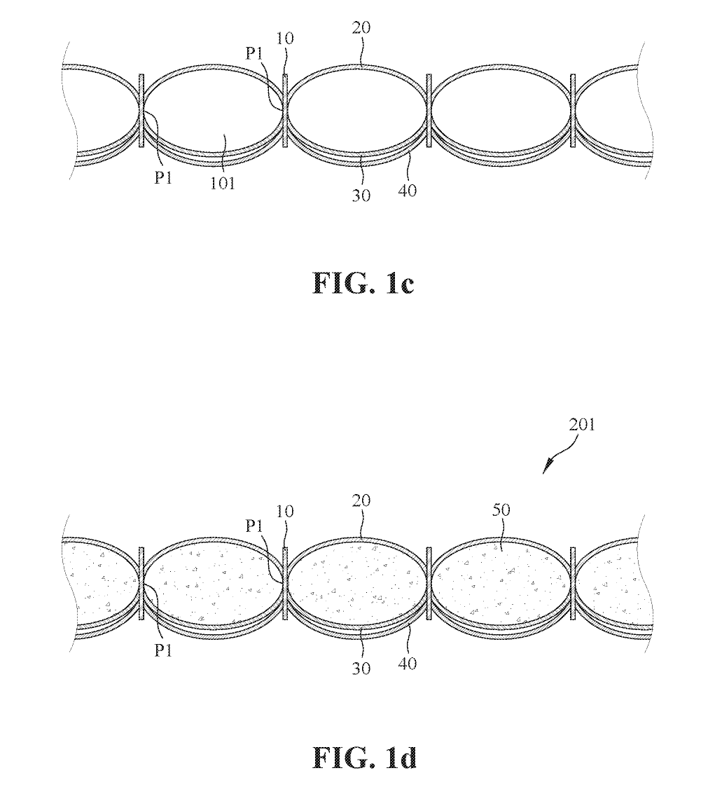

Referring to FIGS. 1a-1d, wherein, FIG. 1a is a flow chart illustrating a method for manufacturing an elastic composite fabric according to a first embodiment of the present invention; FIG. 1b illustrates a first combining step in the method for manufacturing the elastic composite fabric according to the first embodiment of the present invention; FIG. 1c illustrates a second combining step in the method for manufacturing the elastic composite fabric according to the first embodiment of the present invention; and FIG. 1d illustrates a filling step in the method for manufacturing the elastic composite fabric according to the first embodiment of the present invention. The method for manufacturing an elastic composite fabric of the present invention includes the following steps.

A combining step S1a includes the following sub-steps.

A first combining step S11a, where a plurality of sewing threads 10 are sewed through an elastic and/or extensible outer layer 20 and an elastic nonwoven fabric 30 with characteristics to prevent a filling material passing out therefrom along the sewing seams P1 such that the elastic outer layer 20 is disposed onto a top side of the elastic nonwoven fabric 30, thereby defining a plurality of filling spaces 101 between the elastic outer layer 20 and the elastic nonwoven fabric 30, each of the filing spaces 101 is located between adjacent two sewing seams P1, as best shown in FIG. 1b. However, the combining process should not be restricted only to the sewing and/or stitching means, many other methods so long as they can combine the elastic outer layer 20 and the elastic nonwoven fabric 30 together should be included in the present invention. In this embodiment, the elastic and/or extensible outer layer 20 is a knitted fabric, but should not be restricted only thereto and the elastic nonwoven fabric 30 has characteristics to prevent a filling material passing out therefrom, a fiber density of 0.8 to 5.0 denier and a weight of 8 to 100 g/sqm (±40%).

A second combining step S12a, where a first cloth body 40 is combined on a bottom side of the elastic nonwoven fabric 30 through a selected group consisting of glue means, hot pressing and ultrasonic waves, as best shown in FIG. 1c. However, the combining process should not be restricted only to thereto, many other methods so long as they can combine the first cloth body 40 and the elastic nonwoven fabric 30 together should be included in the present invention. In this embodiment, the first cloth body 40 being elastic and serves as another elastic outer layer. Preferably, the first cloth body 40 is a knitted fabric, but should not be restricted only thereto.

A filling step S2a, where a filling material 50 is filled within the plurality of filling spaces 101 between the elastic outer layer 20 and the elastic nonwoven fabric 30 in order to obtain the elastic composite fabric 201 (see FIG. 1d) that prevents the filling material coming out through and detaching off the elastic composite fabric 201. Preferably, the filling material 50 consists of elastic fibers or a polymer mixed with extensible filling materials such that the filling material 50 itself is extensible and/or elastic.

In the method for manufacturing the elastic composite fabric 201 according to the first embodiment of the present invention, since the elastic nonwoven fabric 30 covers the filling material 50 partially, the filling material 50 provides the following advantages.

Firstly, the elastic composite fabric 201 has good elasticity and is extensible.

Secondly, the elastic nonwoven fabric 30 has characteristics to prevent the filling material passing out therefrom and a fiber density of 0.8 to 5.0 denier which is higher than a conventional nonwoven fabric so as to prevent the filling material 50 penetrating through the first cloth body 40 (the effect to prevent fine down through the covering fabric) such that the filling material 50 cannot penetrate through the elastic composite fabric 201 and the latter provides the heat preservation effect in addition that the user's skin does not come into contact with the filling material 50 to avoid itching, such as skin irritation and other discomforts. It can also reduce environmental burdens.

Thirdly, the elastic nonwoven fabric 30 has a weight of 8 to 100 g/sqm (±40%) and is lesser in weight than the conventional nonwoven fabric, and hence provides a fine contact feeling to the skin in addition to prevent the filling material passing out therefrom. An aspect to note is that the more the elastic nonwoven fabric 30 is lesser in weight, the better the feeling contact with the skin becomes, but it is easier for the filling material 50 to penetrate through the elastic nonwoven fabric 30. In reverse, the heavier the elastic nonwoven fabric 30 in weight, the worse the feeling contact with the skin becomes and the filling material 50 is harder to penetrate therethrough.

Fourthly, the elastic nonwoven fabric 30 with characteristics to prevent the filling material passing out therefrom is less expensive than the thermoplastic elastic film and therefore the manufacturing cost can be effectively reduced.

Fifthly, when the elastic nonwoven fabric 30 with characteristics to prevent the filling material passing out therefrom is brought into contact the first cloth body 30 which being elastic and serves as another elastic outer layer can create electrostatic adsorption phenomenon, the elastic composite fabric 201 formed by the two elements further enhances the skin contact comfort of the user.

Finally, the down (the fine feather) forming a part of the filling material 50 within the elastic composite fabric 201 of the present invention does not penetrate to an exterior of the elastic composite fabric 201 even after 10-12 times of washing.

It is to note that the elastic composite fabric 201 manufactured according the first embodiment of the present invention cannot totally prevent the filling material 50 penetrating to an exterior through the elastic outer layer 20.

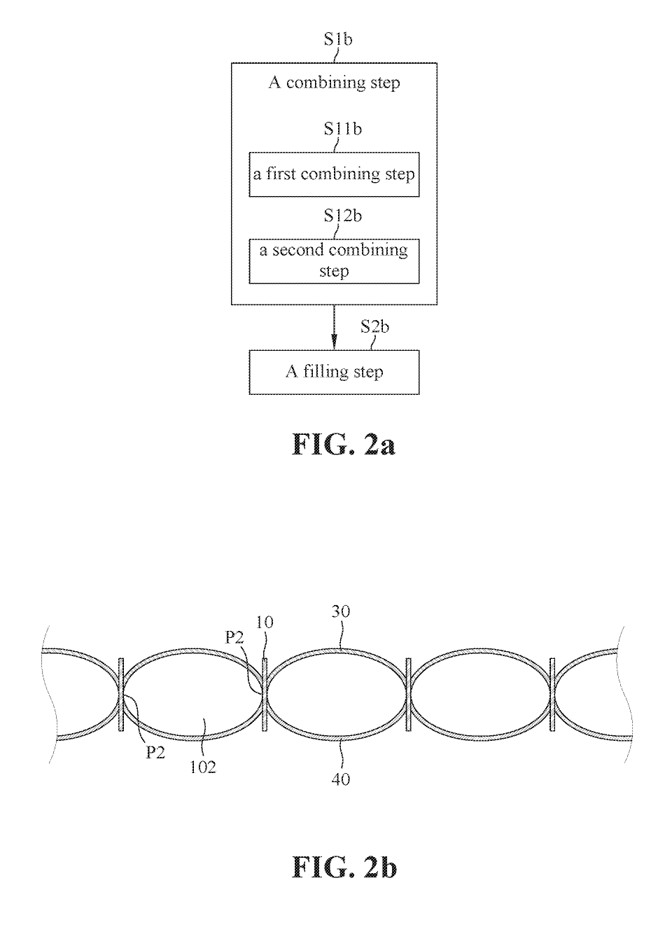

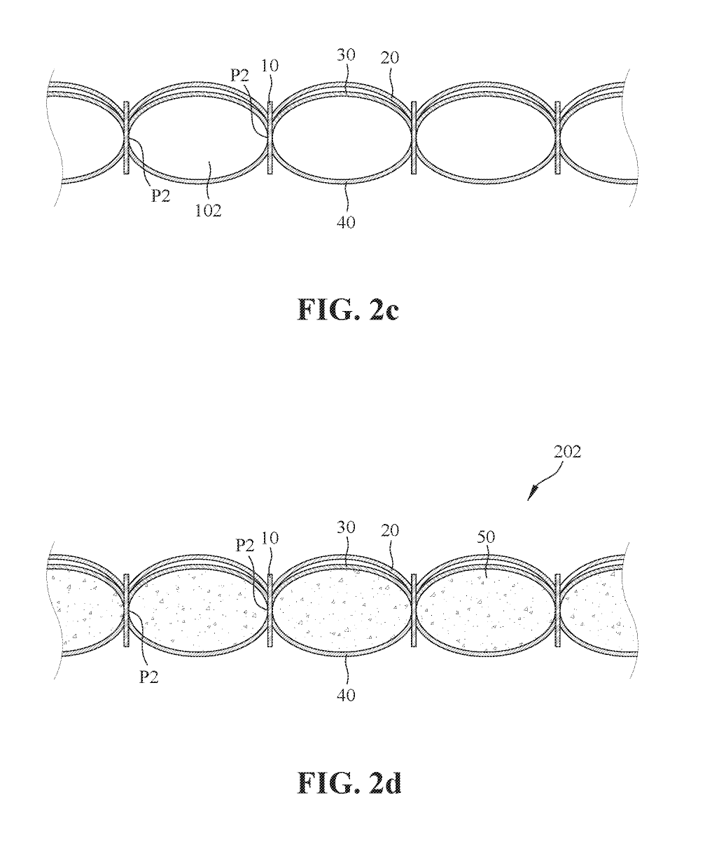

Referring to FIGS. 2a-2d, wherein, FIG. 2a is a flow chart illustrating a method for manufacturing an elastic composite fabric according to a second embodiment of the present invention; FIG. 2b illustrates a first combining step in the method for manufacturing the elastic composite fabric according to the second embodiment of the present invention; FIG. 2c illustrates a second combining step in the method for manufacturing the elastic composite fabric according to the second embodiment of the present invention; and FIG. 2d illustrates a filling step in the method for manufacturing the elastic composite fabric according to the second embodiment of the present invention. The method for manufacturing an elastic composite fabric of the present invention includes the following steps.

A combining step S1b includes the following sub-steps.

A first combining step S11b, where a plurality of sewing threads 10 are sewed through an elastic nonwoven fabric 30 with characteristics to prevent a filling material passing out therefrom and a first cloth body 40 along the sewing seams P2 such that the first cloth body 40 is disposed onto a bottom side of the elastic nonwoven fabric 30, thereby defining a plurality of filling spaces 102 between the elastic nonwoven fabric 30 and the first cloth body 40, each of the filing spaces 102 is located between two sewing seams P2, as best shown in FIG. 2b. However, the combining process should not be restricted only to the sewing and/or stitching means, many other methods so long as they can combine the first cloth body 40 and the elastic nonwoven fabric 30 together should be included in the present invention. In this embodiment, the elastic nonwoven fabric 30 has characteristics to prevent a filling material passing out therefrom, a fiber density of 0.8 to 5.0 denier and a weight of 8 to 100 g/sqm (±40%).

A second combining step S12b, where an elastic and/or extensible outer layer 20 is combined on a top side of the elastic nonwoven fabric 30 through a selected group consisting of glue means, hot pressing and ultrasonic waves, as best shown in FIG. 2c. However, the combining process should not be restricted only to thereto, many other methods so long as they can combine the elastic outer layer 20 and the elastic nonwoven fabric 30 together should be included in the present invention. In this embodiment, the first cloth body 40 being elastic and serves as another elastic outer layer, which in fact is a knitted fabric, but should not be restricted only thereto.

A filling step S2b, where a filling material 50 is filled within the plurality of filling spaces 102 formed between the first cloth body 40 and the elastic nonwoven fabric 30 in order to obtain the elastic composite fabric 202 (see FIG. 2d) that prevents the filling material coming out through and detaching off the elastic composite fabric 202. Preferably, the filling material 50 consists of elastic fibers or a polymer mixed with extensible filling materials such that the filling material 50 itself is extensible and/or elastic.

In the method for manufacturing the elastic composite fabric 202 according to the second embodiment of the present invention, since the elastic nonwoven fabric 30 covers the filling material 50 partially, the elastic composite fabric 202 provides the following advantages. The elastic composite fabric 202 according to the second embodiment provides the first, third and fourth advantages similar to the first embodiment, but not the second advantage. However, since the elastic nonwoven fabric 30 has a fiber density higher than the conventional elastic composite fabric, the filling material 50 is prevented from penetration through the elastic outer layer 20 when compared with the conventional nonwoven fabric, which, in turn, prevents warmth declining effect of the elastic composite fabric 202 and can also reduce environmental burden. In addition, the contact between the elastic nonwoven fabric 30 with characteristics to prevent a filling material passing out therefrom and the elastic outer layer 20 causes electrostatic adsorption phenomenon, the elastic composite fabric 202 formed by the two elements further enhances the skin contact comfort of the user.

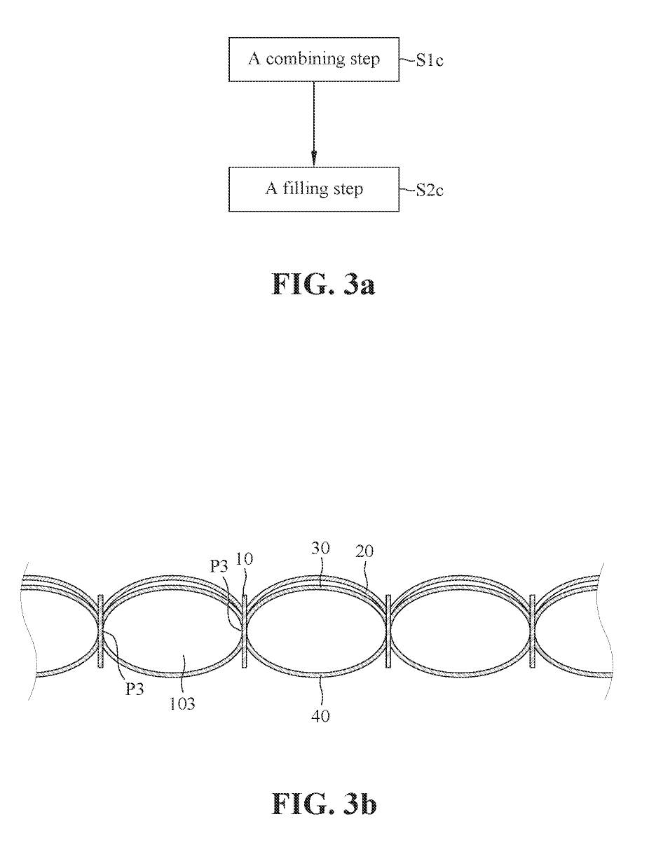

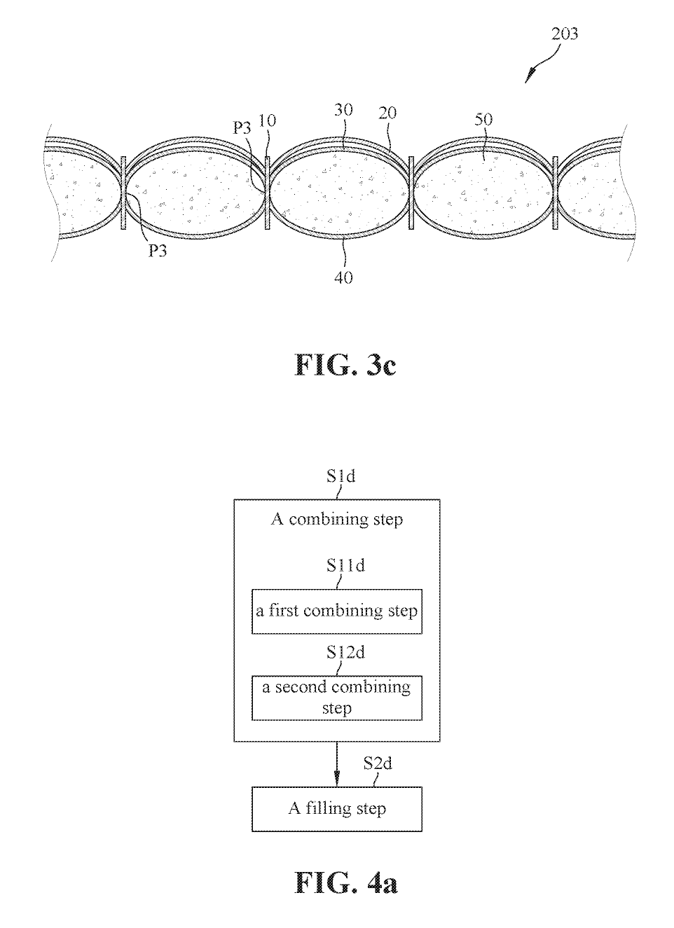

Referring to FIGS. 3a-3c, wherein, FIG. 3a is a flow chart illustrating a method for manufacturing an elastic composite fabric according to a third embodiment of the present invention; FIG. 3b illustrates a combining step in the method for manufacturing the elastic composite fabric according to the third embodiment of the present invention; and FIG. 3c illustrates a filling step in the method for manufacturing the elastic composite fabric according to the third embodiment of the present invention. The method for manufacturing an elastic composite fabric of the present invention includes the following steps.

A combining step S1c, where a plurality of sewing threads 10 are sewed through an elastic and/or extensible outer layer 20, an elastic nonwoven fabric 30 with characteristics to prevent a filling material passing out therefrom and a first cloth body 40 along the sewing seams P3 such that the elastic outer layer 20 is disposed onto a top side of the elastic nonwoven fabric 30 while the first cloth body 40 on a bottom side of the elastic nonwoven fabric 30, thereby defining a plurality of filling spaces 103 between the elastic nonwoven fabric 30 and the first cloth body 40, each of the filing spaces 103 is located between two sewing seams P3, as best shown in FIG. 3b. However, the combining process should not be restricted only to the sewing and/or stitching means, many other methods so long as they can combine the elastic outer layer 20, the nonwoven fabric 30 and the first cloth body 40 together should be included in the present invention. In this embodiment, the elastic outer layer 20 in fact is a knitted fabric, but should not be limited only thereto. The first cloth body 40 can be an elastic nonwoven fabric, which has the characteristics to prevent a filling material passing out therefrom. The elastic nonwoven fabric 30 and the first cloth body 40 (also an elastic nonwoven fabric) both respectively have the characteristics to prevent a filling material passing out therefrom, a fiber density of 0.8 to 5.0 denier and a weight of 8 to 100 g/sqm (±40%).

A filling step S2c, where a filling material 50 is filled within the plurality of filling spaces 103 formed between the first cloth body 40 and the elastic nonwoven fabric 30 in order to obtain the elastic composite fabric 203 (see FIG. 3c) that prevents the filling material coming out through and detaching off the elastic composite fabric 203. Preferably, the filling material 50 consists of elastic fibers or a polymer mixed with extensible filling materials such that the filling material 50 itself is extensible and/or elastic.

In the method for manufacturing the elastic composite fabric 203 according to the third embodiment of the present invention, since the elastic nonwoven fabric 30 having the properties of preventing penetration the filling material therethrough and the first cloth body 40 (also an elastic nonwoven fabric) with the characteristics to prevent a filling material passing out therefrom, enclose and/or cover the filling material 50 totally, the elastic composite fabric 203 provides the following advantages. The elastic composite fabric 203 according to the third embodiment provides the first, third and fourth advantages similar to the first embodiment. Since the elastic nonwoven fabric 30 and the first cloth body 40 (also an elastic nonwoven fabric) both respectively have the characteristics to prevent a filling material passing out therefrom, a fiber density higher than the conventional elastic composite fabric, the filling material 50 is prevented from penetration through the elastic outer layer 20 and the first cloth body 40 (also an elastic nonwoven fabric) when compared with the conventional nonwoven fabric, thereby preventing detachment of the filling material 50 off the elastic composite fabric 203 thoroughly, which, in turn, prevents warmth declining effect of the elastic composite fabric 203 and can also reduce environmental burdens. In other words, the elastic composite fabric according to the third embodiment provides more advantages when compared to that of the first and second embodiments. In addition, the contact between the elastic nonwoven fabric 30 with characteristics to prevent a filling material passing out therefrom and the elastic outer layer 20 causes electrostatic adsorption phenomenon, the composite fabric 203 formed by the two elements further enhances the skin contact comfort of the user.

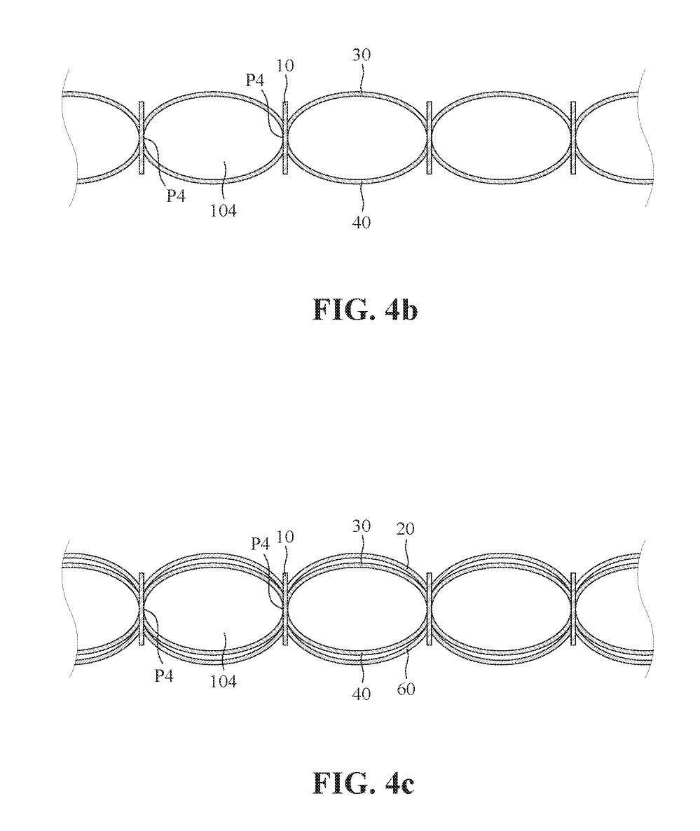

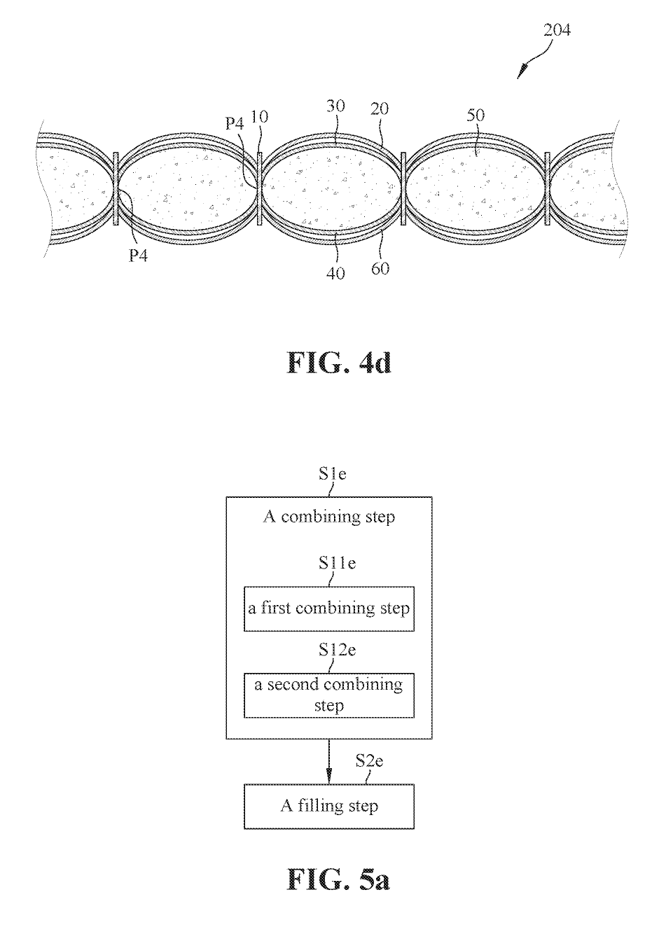

Referring to FIGS. 4a-4d, wherein, FIG. 4a is a flow chart illustrating a method for manufacturing an elastic composite fabric according to a fourth embodiment of the present invention; FIG. 4b illustrates a first combining step in the method for manufacturing the elastic composite fabric according to the fourth embodiment of the present invention; FIG. 4c illustrates a second combining step in the method for manufacturing the elastic composite fabric according to the fourth embodiment of the present invention; and FIG. 4d illustrates a filling step in the method for manufacturing the elastic composite fabric according to the fourth embodiment of the present invention. The method for manufacturing an elastic composite fabric of the present invention includes the following steps.

A combining step S1d includes the following sub-steps.

A first combining step S11d, where a plurality of sewing threads 10 are sewed through an elastic nonwoven fabric 30 with characteristics to prevent a filling material passing out therefrom and a first cloth body 40 along the sewing seams P4 such that the first cloth body 40 is disposed onto a bottom side of the elastic nonwoven fabric 30, thereby defining a plurality of filling spaces 104 between the elastic nonwoven fabric 30 and the first cloth body 40, each of the filing spaces 104 is located between two sewing seams P4, as best shown in FIG. 4b. However, the combining process should not be restricted only to the sewing and/or stitching means, many other methods so long as they can combine the first cloth body 40 and the elastic nonwoven fabric 30 together should be included in the present invention. In this embodiment, the elastic outer layer 20 is preferably a knitted fabric, but should not be limited only thereto. The first cloth body 40 can be an elastic nonwoven fiber, which has the characteristics to prevent a filling material passing out therefrom. The elastic nonwoven fabric 30 and the first cloth body 40 (also an elastic nonwoven fabric) both respectively have the characteristics to prevent a filling material passing out therefrom, a fiber density of 0.8 to 5.0 denier and a weight of 8 to 100 g/sqm (±40%).

A second combining step S12d, where an elastic and/or extensible outer layer 20 is combined on a top side of the elastic nonwoven fabric 30, and a second cloth body 60 on a bottom side of the first cloth body 40, wherein the combining process is selected from a group consisting of glue means, hot pressing and ultrasonic waves, as best shown in FIG. 4c. However, the combining process should not be restricted only to thereto, many other methods so long as they can combine the elastic outer layer 20 and the elastic nonwoven fabric 30 together and can combine the first cloth body 40 and the second cloth body 60 together should be included in the present invention. In this embodiment, the second cloth body 60 being an elastic and/or extensible and serves as yet another elastic outer layer, which is a knitted fabric, but should not be limited only thereto.

A filling step S2d, where a filling material 50 is filled within the plurality of filling spaces 104 formed between the first cloth body 40 and the elastic nonwoven fabric 30 in order to obtain the elastic composite fabric 204 (see FIG. 4d) that prevents the filling material coming out through and detaching off the elastic composite fabric 204. Preferably, the filling material 50 consists of elastic fibers or a polymer mixed with extensible filling materials such that the filling material 50 itself is extensible and/or elastic.

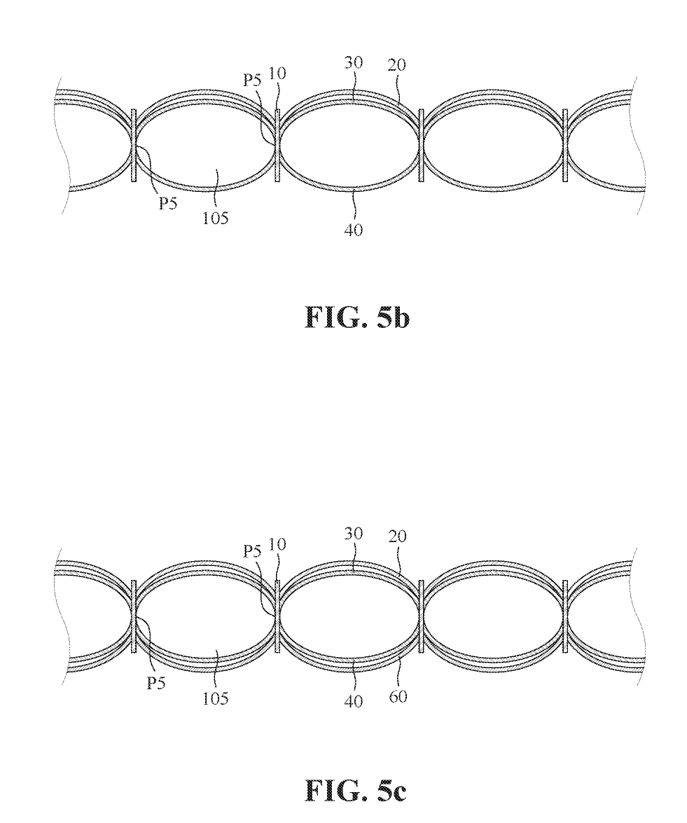

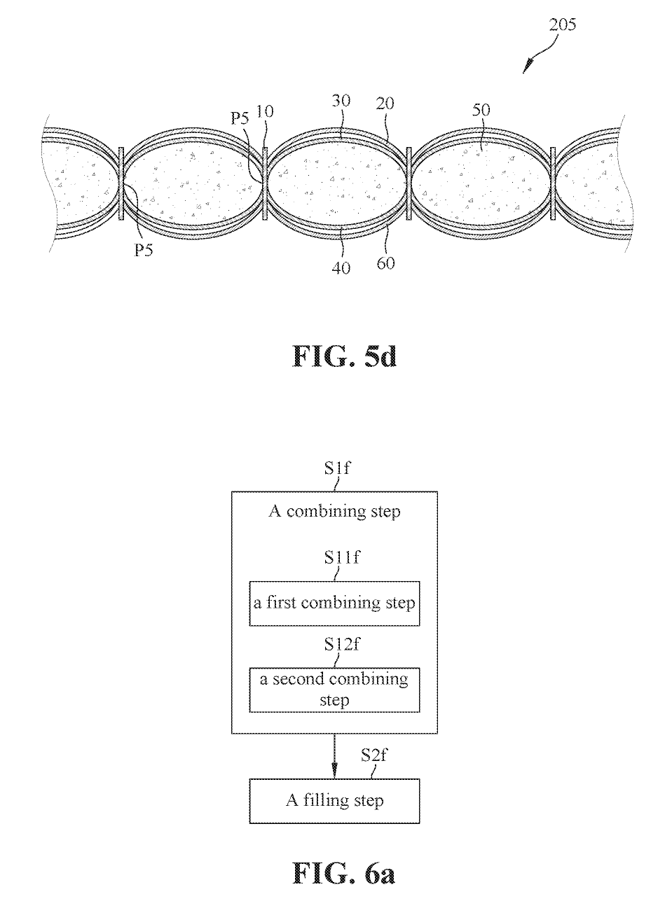

Referring to FIGS. 5a-5d, wherein, FIG. 5a is a flow chart illustrating a method for manufacturing an elastic composite fabric according to a fifth embodiment of the present invention; FIG. 5b illustrates a first combining step in the method for manufacturing the elastic composite fabric according to the fifth embodiment of the present invention; FIG. 5c illustrates a second combining step in the method for manufacturing the elastic composite fabric according to the fifth embodiment of the present invention; and FIG. 5d illustrates a filling step in the method for manufacturing the elastic composite fabric according to the fifth embodiment of the present invention. The method for manufacturing an elastic composite fabric of the present invention includes the following steps.

A combining step S1e includes the following sub-steps.

A first combining step S11e, where a plurality of sewing threads 10 are sewed through an elastic and/or extensible outer layer 20, an elastic nonwoven fabric 30 with characteristics to prevent a filling material passing out therefrom and a first cloth body 40 along the sewing seams P5 such that the elastic outer layer 20 is disposed onto a top side of the elastic nonwoven fabric 30 while the first cloth body 40 is disposed on a bottom side of the elastic nonwoven fabric 30, thereby defining a plurality of filling spaces 105 between the elastic nonwoven fabric 30 and the first cloth body 40, each of the filing spaces 105 is located between two sewing seams P5, as best shown in FIG. 5b. However, the combining process should not be restricted only to the sewing and/or stitching means, many other methods so long as they can combine the elastic outer layer 20 and the first cloth body 40 and the elastic nonwoven fabric 30 together should be included in the present invention. In this embodiment, the elastic outer layer 20 is preferably a knitted fabric, but should not be limited only thereto. The first cloth body 40 has the characteristics to prevent a filling material passing out therefrom and serves as another nonwoven fabric. The elastic nonwoven fabric 30 and the first cloth body 40 (also an elastic nonwoven fabric) both respectively have the characteristics to prevent a filling material passing out therefrom, a fiber density of 0.8 to 5.0 denier and a weight of 8 to 100 g/sqm (±40%).

A second combining step S12e, where a second cloth body 60 is combined on a bottom side of the first cloth body 40, as best shown in FIG. 5c, wherein the combining process is selected from a group consisting of glue means, hot pressing and ultrasonic waves. However, the combining process should not be restricted only to thereto, many other methods so long as they can combine the second cloth body 60 and the first cloth body 40 together should be included in the present invention. In this embodiment, the second cloth body 60 being elastic and/or extensible and serves as yet another elastic outer layer, which is a knitted fabric, but should not be limited only thereto.

A filling step S2e, where a filling material 50 is filled within the plurality of filling spaces 105 formed between the first cloth body 40 and the elastic nonwoven fabric 30 in order to obtain the elastic composite fabric 205 (see FIG. 5d) that prevents the filling material coming out through and detaching off the elastic composite fabric 205. Preferably, the filling material 50 consists of elastic fibers or a polymer mixed with extensible filling materials such that the filling material 50 itself is extensible and/or elastic.

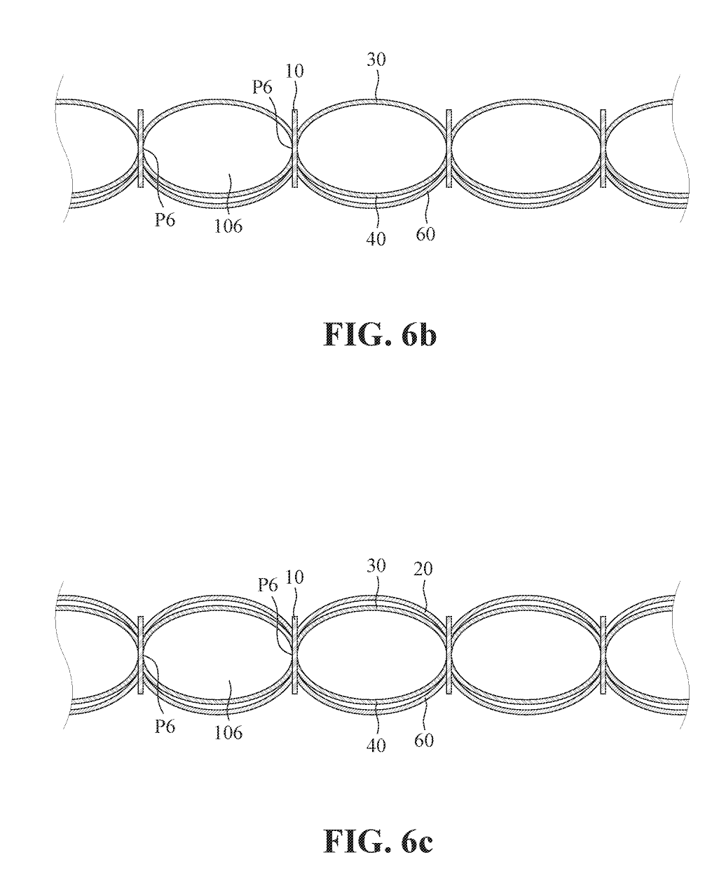

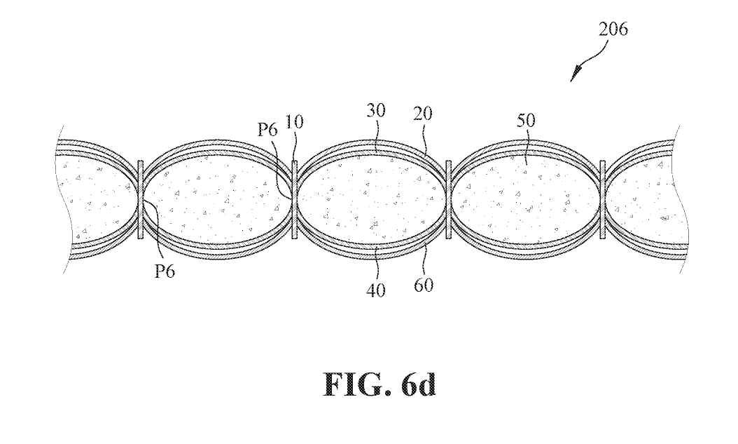

Referring to FIGS. 6a-6d, wherein, FIG. 6a is a flow chart illustrating a method for manufacturing an elastic composite fabric according to a sixth embodiment of the present invention; FIG. 6b illustrates a first combining step in the method for manufacturing the elastic composite fabric according to the sixth embodiment of the present invention; FIG. 6c illustrates a second combining step in the method for manufacturing the elastic composite fabric according to the sixth embodiment of the present invention; and FIG. 6d illustrates a filling step in the method for manufacturing the elastic composite fabric according to the sixth embodiment of the present invention. The method for manufacturing an elastic composite fabric of the present invention includes the following steps.

A combining step S1f includes the following sub-steps.

A first combining step S11f, where a plurality of sewing threads 10 are sewed through an elastic nonwoven fabric 30 with characteristics to prevent a filling material passing out therefrom, a first cloth body 40 and a second cloth body 60 along the sewing seams P6 such that the first cloth body 40 is disposed onto a bottom side of the elastic nonwoven fabric 30 and the second cloth body 60 is disposed on a bottom side of the first cloth body 40, thereby defining a plurality of filling spaces 106 between the elastic nonwoven fabric 30 and the first cloth body 40, each of the filing spaces 106 is located between two sewing seams P6, as best shown in FIG. 6b. However, the combining process should not be restricted only to the sewing and/or stitching means, many other methods so long as they can combine the first cloth body 40 and the elastic nonwoven fabric 30 together and can combine the second cloth body 60 and the first cloth body 40 together should be included in the present invention. In this embodiment, the first cloth body 40 can be an elastic nonwoven fiber, which has the characteristics to prevent a filling material passing out therefrom. The second cloth body 60 is elastic and/or extensible and serves as another elastic outer layer, which is a knitted fabric, but should not be limited only thereto. The elastic nonwoven fabric 30 and the first cloth body 40 (also an elastic nonwoven fabric) both respectively have the characteristics to prevent a filling material passing out therefrom, a fiber density of 0.8 to 5.0 denier and a weight of 8 to 100 g/sqm (±40%).

A second combining step S12f, where an elastic and/or extensible outer layer 20 is combined on a top side of the elastic nonwoven fabric 30, as best shown in FIG. 6c, wherein the combining process is selected from a group consisting of glue means, hot pressing and ultrasonic waves. However, the combining process should not be restricted only to thereto, many other methods so long as they can combine the elastic outer layer 20 and the elastic nonwoven fabric 30 together should be included in the present invention. In this embodiment, the elastic outer layer 20 is a knitted fabric, but should not be limited only thereto.

A filling step S2f, where a filling material 50 is filled within the plurality of filling spaces 106 formed between the first cloth body 40 and the elastic nonwoven fabric 30 in order to obtain the elastic composite fabric 206 (see FIG. 6d) that prevents the filling material coming out through and detaching off the elastic composite fabric 206. Preferably, the filling material 50 consists of elastic fibers or a polymer mixed with extensible filling materials such that the filling material 50 itself is extensible and/or elastic.

In the method for manufacturing the elastic composite fabric 204-206 according to the fourth to sixth embodiments of the present invention, since the elastic nonwoven fabric 30 having the properties of preventing penetration the filling material therethrough and the first cloth body 40 (also an elastic nonwoven fabric) with the characteristics to prevent a filling material passing out therefrom, enclose and/or cover the filling material 50 totally, the elastic composite fabric 204-206 provides the following advantages. The elastic composite fabric 204-206 accordingly provides the advantages similar to the third embodiment, and owing to the second cloth body 60 serving as yet another elastic outer layer protecting the first cloth body 40. In addition, the contact between the first cloth body 40 with characteristics to prevent a filling material passing out therefrom and the second cloth body 60 causes electrostatic adsorption phenomenon, the elastic composite fabric 204-206 formed by the two elements further enhances the skin contact comfort of the user.

One aspect to note is that in the manufacturing method of the first to sixth embodiments of the present invention, the elastic and/or extensible outer layer includes a fiber material having elastic and/or extensible higher softening temperature than the temperature given during the bonding. The fiber material includes PE (polyethylene), PP (Polypropylene), PAN (polyacrylonitrile), PB (Polybutene), PTFE (Polytetrafluoroethylene), PET (Polyethylene terephthalate), PBT (Polybutylene terephthalate), PTT (Poly trimethylene terephthalate), PVA (Polyvinyl acetate), PVB (Polyvinyl butyral), PA (Polyacrylate), PMA (Polymethyl acrylate), PMMA (Polymethylmethacrylate), Nylon 6, Nylon 66, PVC (PolyVinyl Chloride), PVDC (Polyvinylidene chloride), PS (Polystyrene), PVA (Polyvinyl alcohol), PU (Polyurethane), PLA (Polylactide) and other materials are combined to form the fabric. The elastic nonwoven fabric with the characteristics of preventing the penetration of the filling material is a single direction extensible or dual-direction extensible, with the elasticity between 50 and 300%, SMMS (Spunbond-Meltblown-Meltblown-Spunbond), SMS (Spunbond-Meltblown-Spunbond), SSMMS (Spunbond-Spunbond-Meltblown-Meltblown-Spunbond), SSMMMS (Spunbond-Spunbond-Meltblown-Meltblown-Meltblown-Spunbond), SMMMS (Spunbond-Meltblown-Meltblown-Meltblown-Spunbond), SMMMSS (Spunbond-Meltblown-Meltblown-Meltblown-Spunbond-Spunbond), SSMMMSS (Spunbond-Spunbond-Meltblown-Meltblown-Meltblown-Spunbond-Spunbond), spunlace nonwoven, air-through nonwoven, thermal bonded nonwoven fabrics made of thermoplastic materials are preferred for raw materials. The fiber material usually has a softening temperature higher than the temperature given during the bonding, for example, PE (polyethylene), PP (Polypropylene), PAN (polyacrylonitrile), PB (Polybutene), PTFE (Polytetrafluoroethylene), PET (Polyethylene terephthalate), PBT (Polybutylene terephthalate), PTT (Poly trimethylene terephthalate), PVA (Polyvinyl acetate), PVB (Polyvinyl butyral), PA (Polyacrylate), PMA (Polymethyl acrylate), PMMA (Polymethylmethacrylate), Nylon 6, Nylon 66, PVC (PolyVinyl Chloride), PVDC (Polyvinylidene chloride), PS (Polystyrene), PVA (Polyvinyl alcohol), PU (Polyurethane), PLA (Polylactide) and their copolymers, etc. can be used as non-woven materials. In addition, other elastic nonwoven fabrics that have the property of preventing the filling material from penetrating can also use other biodegradable polymers. The material of the elastic nonwoven fabric having the property of preventing the penetration of the filling material may also be a synthetic or natural cellulose polymer, such as not restricted including cellulose ester, cellulose ether, nitrocellulose, cellulose acetate, cellulose acetate butyrate, ethyl cellulose, regenerated cellulose (eg, viscose, rayon, etc.). It should be noted that the polymer may also contain other additives, for example: processing aids or treatment compositions to impart desired properties, residual amounts of solvents, pigments or colorants, etc. to the fibers. Preferably, the elastic nonwoven fabric having the property of preventing the penetration of the filling material can be a monocomponent fiber and/or a multi-component fiber. In general, the monocomponent fibers are prepared from polymers or blends of polymers extruded from a single extruder while multi-component fibers are usually prepared from two or more polymers (e.g. bicomponent fibers) extruded from separate extruders. The polymer can be disposed in different regions of the substantially fixed positioning through the cross section of the fiber. The components can be disposed in any desired configuration, such as sheath-core, side-by-side, pie-type, star-shaped, tri-island, bovine-eye, or other known various configurations. The filling materials are commonly used thermal insulation materials such as down, cotton, man-made fibers, hot air cloths, etc.; however, it is not limited thereto, and any filling material commonly used in the textile field can be a filling material.

In addition, the elastic composite fabrics 201-206 made by the manufacturing method of the present invention to prevent the filling materials from penetration can be applied to all products in the textile field, especially warm products (such as clothes, coats, vests, trousers, etc.) (Pillows, comforter, etc.), and the thickness of the elastic composite fabrics 201-206 preventing the filling materials from penetration can be adjusted according to the needs of the product and its extension direction (one-way extension or two-way extension).

Referring again to FIGS. 1c to 1d, in this embodiment, the elastic composite fabric 201 with the characteristics to prevent a filling material passing out therefrom, includes an elastic nonwoven fabric 30 with characteristics to prevent a filling material passing out therefrom, an elastic and/or extensible outer layer 20, a first cloth body 40, a filling material 50 and a plurality of sewing threads 10.

The plurality of sewing threads 10 are sewed through the elastic outer layer 20 and the elastic nonwoven fabric 30 with characteristics to prevent a filling material passing out therefrom along the sewing seams P1 such that the elastic outer layer 20 is disposed onto a top side of the elastic nonwoven fabric 30, thereby defining a plurality of filling spaces 101 between the elastic outer layer 20 and the elastic nonwoven fabric 30, each of the filing spaces 101 is located between two sewing seams P1. However, the combining process should not be restricted only to the sewing and/or stitching means, many other methods so long as they can combine the elastic outer layer 20 and the elastic nonwoven fabric 30 together should be included in the present invention. In this embodiment, the elastic and/or extensible outer layer 20 is a knitted fabric, but should not be restricted only thereto. The first cloth body 40 is disposed onto a bottom side of the elastic nonwoven fabric 30, wherein, disposing of the first cloth body 40 onto the bottom side of the elastic nonwoven fabric 30 is selected from a group consisting of glue means, hot pressing and ultrasonic waves. However, the disposing process should not be restricted only to thereto, many other methods so long as they can combine the elastic nonwoven fabric 30 and the first cloth body 40 together should be included in the present invention. The first cloth body 40 being elastic and serves as another elastic outer layer. The elastic nonwoven fabric has the characteristics to prevent the filling material passing out therefrom, a fiber density of 0.8 to 5.0 denier which is a higher than a conventional nonwoven fabric, and a weight of 8 to 100 g/sqm (±40%) while the filling material 50 is filled within a plurality of filling spaces 101 formed between the elastic outer layer 20 and the elastic nonwoven fabric 30. Preferably, the filling material 50 consists of elastic fibers or a polymer mixed with extensible filling materials such that the filling material itself is extensible.

It is to note that the elastic composite fabric 201 manufactured according the present invention, since the elastic nonwoven fabric 30 partially covers the filling material 50, provides the following advantages.

Firstly, the elastic composite fabric 201 has good elasticity and is extensible.

Secondly, the elastic nonwoven fabric 30 has characteristics to prevent the filling material passing out therefrom and a fiber density of 0.8 to 5.0 denier which is higher than a conventional nonwoven fabric so as to prevent the filling material 50 penetrating through the first cloth body 40 (the effect to prevent fine down through the covering fabric) such that the filling material 50 cannot penetrate through the elastic composite fabric 201 and the latter provides the heat preservation effect in addition that the user's skin does not come into contact with the filling material 50 to avoid itching, such as skin irritation and other discomforts. It can also reduce environmental burdens.

Thirdly, the elastic nonwoven fabric 30 has a weight of 8 to 100 g/sqm (±40%) and is lesser in weight than the conventional nonwoven fabric, and hence provides a fine contact feeling to the skin in addition to prevent the filling material passing out therefrom. An aspect to note is that the more the elastic nonwoven fabric 30 is lesser in weight, the better the feeling contact with the skin becomes, but it is easier for the filling material 50 to penetrate through the elastic nonwoven fabric 30. In reverse, the heavier the elastic nonwoven fabric 30 in weight, the worse the feeling contact with the skin becomes and the filling material 50 is harder to penetrate therethrough.

Fourthly, the elastic nonwoven fabric 30 with characteristics to prevent the filling material passing out therefrom is less expensive than the thermoplastic elastic film and therefore the manufacturing cost can be effectively reduced.

Fifthly, when the elastic nonwoven fabric 30 with characteristics to prevent the filling material passing out therefrom is brought into contact the first cloth body 30 which being elastic and serves as another elastic outer layer can create electrostatic adsorption phenomenon, the elastic composite fabric 201 formed by the two elements further enhances the skin contact comfort of the user.

Finally, the down (the fine feather) forming a part of the filling material 50 within the elastic composite fabric 201 of the present invention does not penetrate to an exterior of the elastic composite fabric 201 even after 10-12 times of washing.

It is to note that the elastic composite fabric 201 manufactured according to the present invention cannot totally prevent the filling material 50 penetrating to an exterior through the elastic outer layer 20.

Referring again to FIGS. 2a-2d, according to the second embodiment of the present invention, the elastic composite fabric 202 with the characteristics to prevent a filling material passing out therefrom, includes an elastic nonwoven fabric 30 with characteristics to prevent a filling material passing out therefrom, an elastic and/or extensible outer layer 20, a first cloth body 40, a filling material 50 and a plurality of sewing threads 10.

The plurality of sewing threads 10 are sewed through the elastic nonwoven fabric 30 with characteristics to prevent a filling material passing out therefrom and the first cloth body 40 along the sewing seams P2 such that the first cloth body 40 is disposed onto a bottom side of the elastic nonwoven fabric 30, thereby defining a plurality of filling spaces 102 between the first cloth body 40 and the elastic nonwoven fabric 30, each of the filing spaces 102 is located between two sewing seams P2. However, the combining process should not be restricted only to the sewing and/or stitching means, many other methods so long as they can combine the first cloth body 40 and the elastic nonwoven fabric 30 together should be included in the present invention. In this embodiment, the elastic outer layer 20 is disposed on a top side of the elastic nonwoven fabric 30, wherein, disposing of the elastic outer layer 20 onto the top side of the elastic nonwoven fabric 30 is selected from a group consisting of glue means, hot pressing and ultrasonic waves. However, the disposing process should not be restricted only to thereto, many other methods so long as they can combine the elastic nonwoven fabric 30 and the elastic outer layer 20 together should be included in the present invention. The first cloth body 40 being elastic and serves as another elastic outer layer, which in fact is a knitted fabric, but should not be restricted only thereto. The elastic nonwoven fabric 30 has the characteristics to prevent a filling material passing out therefrom, a fiber density of 0.8 to 5.0 denier and a weight of 8 to 100 g/sqm (±40%). The filling material 50 is filled within a plurality of filling spaces 102 formed between the elastic nonwoven fabric 30 and the first cloth body 40. Preferably, the filling material 50 consists of elastic fibers or a polymer mixed with extensible filling materials such that the filling material 50 itself is extensible and/or elastic.

The elastic composite fabric 202 according to the present invention, since the elastic nonwoven fabric 30 covers the filling material 50 partially, the elastic composite fabric 202 provides the following advantages. The elastic composite fabric 202 accordingly provides the first, third and fourth advantages similar to the first embodiment, but not the second advantage. However, since the elastic nonwoven fabric 30 has a fiber density higher than the conventional elastic composite fabric, the filling material 50 is prevented from penetration through the elastic outer layer 20 when compared with the conventional nonwoven fabric, which, in turn, prevents warmth declining effect of the elastic composite fabric 202 and can also reduce environmental burden. In addition, the contact between the elastic nonwoven fabric 30 with characteristics to prevent a filling material passing out therefrom and the elastic outer layer 20 causes electrostatic adsorption phenomenon, the elastic composite fabric 202 formed by the two elements further enhances the skin contact comfort of the user.

Referring again to FIGS. 3b-3c, according to the third embodiment of the present invention, the elastic composite fabric 203 with the characteristics to prevent a filling material passing out therefrom, includes an elastic nonwoven fabric 30 with characteristics to prevent a filling material passing out therefrom, an elastic and/or extensible outer layer 20, a first cloth body 40, a filling material 50 and a plurality of sewing threads 10.

The plurality of sewing threads 10 are sewed through the elastic outer layer 20, the elastic nonwoven fabric 30 with characteristics to prevent a filling material passing out therefrom and the first cloth body 40 along the sewing seams P3 such that the elastic outer layer 20 is disposed on a top side of the elastic nonwoven fabric 30 while the first cloth body 40 is disposed onto a bottom side of the elastic nonwoven fabric 30, thereby defining a plurality of filling spaces 103 between the elastic nonwoven fabric 30 and the first cloth body 40, each of the filing spaces 103 is located between two sewing seams P3. However, the disposing process should not be restricted only to the sewing and/or stitching means, many other methods so long as they can combine the elastic outer layer 20, the first cloth body 40 and the elastic nonwoven fabric 30 together should be included in the present invention. In this embodiment, the elastic outer layer 20 in fact is a knitted fabric, but should not be limited only thereto. The first cloth body 40 can be an elastic nonwoven fabric, which has the characteristics to prevent a filling material passing out therefrom. The elastic nonwoven fabric 30 and the first cloth body 40 (also an elastic nonwoven fabric) both respectively have the characteristics to prevent a filling material passing out therefrom, a fiber density of 0.8 to 5.0 denier and a weight of 8 to 100 g/sqm (±40%). The filling material 50 is filled within the plurality of filling spaces 103 formed between the elastic nonwoven fabric 30 and the first cloth body 40. Preferably, the filling material 50 consists of elastic fibers or a polymer mixed with extensible filling materials such that the filling material 50 itself is extensible and/or elastic.

The elastic composite fabric 203 according to the present invention, since the elastic nonwoven fabric 30 having the properties of preventing penetration the filling material therethrough and the first cloth body 40 (also an elastic nonwoven fabric) with the characteristics to prevent a filling material passing out therefrom enclose and/or cover the filling material 50 totally, the elastic composite fabric 203 provides the following advantages. The elastic composite fabric 203 according to the third embodiment provides the first, third and fourth advantages similar to the first embodiment. Since the elastic nonwoven fabric 30 and the first cloth body 40 (also an elastic nonwoven fabric) both respectively have the characteristics to prevent a filling material passing out therefrom, a fiber density higher than the conventional elastic composite fabric, the filling material 50 is prevented from penetration through the elastic outer layer 20 and the first cloth body 40 (also an elastic nonwoven fabric) when compared with the conventional nonwoven fabric, thereby preventing detachment of the filling material 50 off the elastic composite fabric 203 thoroughly, which, in turn, prevents warmth declining effect of the elastic composite fabric 203 and can also reduce environmental burdens. In other words, the elastic composite fabric 203 according to the third embodiment more advantages when compared to that of the first and second embodiment. In addition, the contact between the elastic nonwoven fabric 30 with characteristics to prevent a filling material passing out therefrom and the elastic outer layer 20 causes electrostatic adsorption phenomenon, the composite fabric 203 formed by the two elements further enhances the skin contact comfort of the user.

Referring again to FIGS. 4c-4d, according to the fourth embodiment of the present invention, the elastic composite fabric 204 with the characteristics to prevent a filling material passing out therefrom, includes an elastic nonwoven fabric 30 with characteristics to prevent a filling material passing out therefrom, an elastic and/or extensible outer layer 20, a first cloth body 40, a second cloth body 60, a filling material 50 and a plurality of sewing threads 10.

The plurality of sewing threads 10 are sewed through the elastic nonwoven fabric 30 with characteristics to prevent a filling material passing out therefrom and the first cloth body 40 along the sewing seams P4 such that the first cloth body 40 is disposed on a bottom side of the elastic nonwoven fabric 30, thereby defining a plurality of filling spaces 104 between the elastic nonwoven fabric 30 and the first cloth body 40, each of the filing spaces 104 is located between two sewing seams P4. However, the disposing process should not be restricted only to the sewing and/or stitching means, many other methods so long as they can combine the first cloth body 40 and the elastic nonwoven fabric 30 together should be included in the present invention. In this embodiment, the elastic outer layer 20 is preferably a knitted fabric, but should not be limited only thereto. The first cloth body 40 can be an elastic nonwoven fabric, which has the characteristics to prevent a filling material passing out therefrom. The elastic outer layer 20 is disposed on a top side of the elastic nonwoven fabric 30 through a selected group consisting of glue means, hot pressing and ultrasonic waves while the second cloth body 60 is disposed on a bottom side of the first cloth body 40 through a selected group consisting of glue means, hot pressing and ultrasonic waves. However, the disposing process should not be restricted only to thereto, many other methods so long as they can combine the elastic outer layer 20 and the elastic nonwoven fabric 30 together and can combine the first cloth body 40 and the second cloth body 60 together should be included in the present invention. In this embodiment, the second cloth body 60 being an elastic and/or extensible and serves as yet another elastic outer layer, which in fact is a nonwoven fabric, but should not be limited only thereto. The elastic nonwoven fabric 30 and the first cloth body 40 (also an elastic nonwoven fabric) both respectively have the characteristics to prevent a filling material passing out therefrom, a fiber density of 0.8 to 5.0 denier and a weight of 8 to 100 g/sqm (±40%). The filling material 50 is filled within the plurality of filling spaces 104 formed between the elastic nonwoven fabric 30 and the first cloth body 40. Preferably, the filling material 50 consists of elastic fibers or a polymer mixed with extensible filling materials such that the filling material 50 itself is extensible and/or elastic.

Referring again to FIGS. 5c-5d, according to the fifth embodiment of the present invention, the elastic composite fabric 205 with the characteristics to prevent a filling material passing out therefrom, includes an elastic nonwoven fabric 30 with characteristics to prevent a filling material passing out therefrom, an elastic and/or extensible outer layer 20, a first cloth body 40, a second cloth body 60, a filling material 50 and a plurality of sewing threads 10.

The plurality of sewing threads 10 are sewed through the elastic outer layer 20, the elastic nonwoven fabric 30 with characteristics to prevent a filling material passing out therefrom and the first cloth body 40 along the sewing seams P5 such that the elastic outer layer 20 is disposed on a top side of the elastic nonwoven fabric 30 while the first cloth body 40 is disposed on a bottom side of the elastic nonwoven fabric 30, thereby defining a plurality of filling spaces 105 between the first cloth body 40 and the elastic nonwoven fabric 30, each of the filing spaces 105 is located between two sewing seams P5. However, the disposing process should not be restricted only to the sewing and/or stitching means, many other methods so long as they can combine the elastic outer layer 20, the first cloth body 40 and the elastic nonwoven fabric 30 together should be included in the present invention. In this embodiment, the elastic outer layer 20 is preferably a knitted fabric, but should not be limited only thereto. The first cloth body 40 can be an elastic nonwoven fabric, which has the characteristics to prevent a filling material passing out therefrom. The second cloth body 60 is disposed on a bottom side of the first cloth body 40 through a selected group consisting of glue means, hot pressing and ultrasonic waves. However, the disposing process should not be restricted only thereto, many other methods so long as they can combine the second cloth body 60 and the first cloth body 40 together should be included in the present invention. The second cloth body 60 being elastic and/or extensible and serves as yet another elastic outer layer, which in fact is a knitted fabric, but should not be limited only thereto. The elastic nonwoven fabric 30 and the first cloth body 40 (also an elastic nonwoven fabric) both respectively have the characteristics to prevent a filling material passing out therefrom, a fiber density of 0.8 to 5.0 denier and a weight of 8 to 100 g/sqm (±40%). The filling material 50 is filled within the plurality of filling spaces 105 formed between the elastic nonwoven fabric 30 and the first cloth body 40. Preferably, the filling material 50 consists of elastic fibers or a polymer mixed with extensible filling materials such that the filling material 50 itself is extensible and/or elastic.

Referring again to FIGS. 6c-6d, according to the sixth embodiment of the present invention, the elastic composite fabric 206 with the characteristics to prevent a filling material passing out therefrom, includes an elastic nonwoven fabric 30 with characteristics to prevent a filling material passing out therefrom, an elastic and/or extensible outer layer 20, a first cloth body 40, a second cloth body 60, a filling material 50 and a plurality of sewing threads 10.

The plurality of sewing threads 10 are sewed through the elastic nonwoven fabric 30 with characteristics to prevent a filling material passing out therefrom, the first cloth body 40 and the second cloth body 60 along the sewing seams P6 such that the first cloth body 40 is disposed on a bottom side of the elastic nonwoven fabric 30 while the second cloth body 60 is disposed on a bottom side of the first body 40, thereby defining a plurality of filling spaces 106 between the elastic nonwoven fabric 30 and the first cloth body 40, each of the filing spaces 106 is located between two sewing seams P6. The disposing process should not be limiting only to the sewing and/or stitching means, many other methods so long as they can combine the first cloth body 40 and the elastic nonwoven fabric 30 together and can combine the first cloth body 40 and the second cloth body 60 together should be included in the present invention. The first cloth body 40 can be an elastic nonwoven fabric, which has the characteristics to prevent a filling material passing out therefrom. The second cloth body 60 has an extensible outer surface and in fact is a knitted fabric. The elastic nonwoven fabric 30 and the first cloth body 40 (also an elastic nonwoven fabric) both respectively have the characteristics to prevent a filling material passing out therefrom, a fiber density of 0.8 to 5.0 denier and a weight of 8 to 100 g/sqm (±40%). The elastic outer layer 20 is disposed on a top side of the elastic nonwoven fabric 30 through a selected group consisting of glue means, hot pressing and ultrasonic waves. However, the disposing process should not be restricted only thereto, many other methods so long as they can combine the elastic outer layer 20 and the elastic nonwoven fabric 30 together should be included in the present invention. The filling material 50 is filled within the plurality of filling spaces 106 formed between the elastic nonwoven fabric 30 and the first cloth body 40. Preferably, the filling material 50 consists of elastic fibers or a polymer mixed with extensible filling materials such that the filling material 50 itself is extensible and/or elastic.

The elastic composite fabric 204-206 according to the fourth to sixth embodiments of the present invention, since the elastic nonwoven fabric 30 having the properties of preventing penetration the filling material therethrough and the first cloth body 40 (also an elastic nonwoven fabric) with the characteristics to prevent the filling material passing out therefrom, enclose and/or cover the filling material 50 totally, the elastic composite fabric 204-206 provides the advantages similar to the third embodiment, and further the second cloth body 60 serving as yet another elastic outer layer protects the first cloth body 40. In addition, the contact between the first cloth body 40 with characteristics to prevent a filling material passing out therefrom and the second cloth body 60 causes electrostatic adsorption phenomenon, the elastic composite fabric 204-206 formed by the two elements further enhances the skin contact comfort of the user.

One aspect to note is the elastic composite fabric 201-206 manufactured according to the first to sixth embodiments of the present invention includes a fiber material having an elastic or extensible surface layer and the filling material having the characteristics of preventing the filler from passing out. The materials described above are not repeated herein.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for manufacturing an elastic composite fabric, comprising following steps:
combining step: combining an elastic outer layer onto a top side of an elastic nonwoven fabric, which has characteristics to prevent a filling material passing out therefrom, a fiber density of 0.8 to 5.0 denier and a weight of 8 to 100 g/sqm (±40%), and a first cloth body onto a bottom side of said elastic nonwoven fabric, wherein, said first cloth body being elastic and serves as another elastic outer layer or said first cloth body has characteristics to prevent the filling material passing out therefrom and serves as another elastic nonwoven fabric with a fiber density of 0.8 to 5.0 denier and a weight of 8 to 100 g/sqm (±40%); and
filling step: filling the filling material within a plurality of filling spaces between said elastic outer layer and said elastic nonwoven fabric or within a plurality of filling spaces between said elastic nonwoven fabric and said first cloth body in order to obtain the elastic composite fabric that prevents the filling material coming out through the elastic composite fabric.

2. The method according to claim 1, wherein said combining of said elastic outer layer onto said top side of said elastic nonwoven fabric is selected from a group consisting of sewing thread stitching means, glue means, hot pressing and ultrasonic waves, wherein said combining of said first cloth body onto said bottom side of said elastic nonwoven fabric is selected from a group consisting of sewing thread stitching means, glue means, hot pressing and ultrasonic waves.

3. The method according to claim 1, wherein the combining step further includes a step of combining a second cloth body onto a bottom side of said first cloth body such that said second cloth body is elastic and serves as yet another elastic outer layer, said first cloth body being an elastic nonwoven fabric having the characteristics of preventing the filling material from passing through the composite fabric.

4. The method according to claim 3, wherein said combining of said elastic outer layer onto said top side of said elastic nonwoven fabric is selected from a group consisting of sewing thread stitching means, glue means, hot pressing and ultrasonic waves, said combining of said first cloth body onto said bottom side of said elastic nonwoven fabric is selected from a group consisting of sewing thread stitching means, glue means, hot pressing and ultrasonic waves, and said combining of said second cloth body onto said bottom side of said first cloth body is selected from a group consisting of sewing thread stitching means, glue means, hot pressing and ultrasonic waves.

5. The method according to claim 1, wherein said filling material consists of elastic fibers or a polymer mixed with extensible filling materials such that said filling material is extensible.

6. An elastic composite fabric comprising:
an elastic nonwoven fabric which has characteristics to prevent a filling material passing out therefrom, a fiber density of 0.8 to 5.0 denier and a weight of 8 to 100 g/sqm (±40%);
an elastic outer layer disposed onto a top side of said elastic nonwoven fabric;
a first cloth body disposed onto a bottom side of said elastic nonwoven fabric, wherein, said first cloth body being elastic and serves as another elastic outer layer or said first cloth body has characteristics to prevent a filling material passing out therefrom and serves as another elastic nonwoven fabric with a fiber density of 0.8 to 5.0 denier and a weight of 8 to 100 g/sqm (±40%); and
a filling material filled within a plurality of filling spaces between said elastic outer layer and said elastic nonwoven fabric or within a plurality of filling spaces between said elastic nonwoven fabric and said first cloth body.

7. The elastic composite fabric according to claim 6, wherein disposing of said elastic outer layer onto said top side of said elastic nonwoven fabric is selected from a group consisting of sewing thread stitching means, glue means, hot pressing and ultrasonic waves, wherein disposing of said first cloth body onto said bottom side of said elastic nonwoven fabric is selected from a group consisting of sewing thread stitching means, glue means, hot pressing and ultrasonic waves.

8. The elastic composite fabric according to claim 6, further comprising a second cloth body disposed onto a bottom side of said first cloth body such that said second cloth body is elastic and serves as yet another elastic outer layer, said first cloth body being an elastic nonwoven fabric having the characteristics of preventing the filling material from passing through the composite fabric.

9. The elastic composite fabric according to claim 8, wherein disposing of said elastic outer layer onto said top side of said elastic nonwoven fabric is selected from a group consisting of sewing thread stitching means, glue means, hot pressing and ultrasonic waves, and disposing of said first cloth body onto said bottom side of said elastic nonwoven fabric is selected from a group consisting of sewing thread stitching means, glue means, hot pressing and ultrasonic waves, and disposing of said second cloth body onto said bottom side of said first cloth body is selected from a group consisting of sewing thread stitching means, glue means, hot pressing and ultrasonic waves.

10. The elastic composite fabric according to claim 6, wherein said filling material consists of elastic fibers or a polymer mixed with extensible filling materials such that said filling material is extensible.
